(19) United States
(12) Patent Application Publication
(10) Pub. No.: US 2024/0240860 A1
(43) Pub. Date: Jul. 18, 2024

(54) VACUUM FREEZE-DRYER COMPRISING APPARATUS FOR SEPARATING MOISTURE FROM OIL AND METHOD OF CONTROLLING THE SAME

(71) Applicant: MEDIKAN CO., LTD., Seoul (KR)

(72) Inventors: Hee Young LEE, Seoul (KR); Byung Young JUHN, Seoul (KR); Min Jae LEE, Seoul (KR)

(73) Assignee: MEDIKAN CO., LTD., Seoul (KR)

(21) Appl. No.: 18/288,327

(22) PCT Filed: Mar. 21, 2022
(86) PCT No.: PCT/KR2022/003868

§ 371 Date: Oct. 25, 2023

(30) Foreign Application Priority Data
Apr. 30, 2021 (KR) 10-2021-0056303

(51) Int. Cl. F26B 5/06; F26B 9/06

(52) U.S. Cl. CPC F26B 5/06; F26B 9/06

(57) ABSTRACT

A vacuum freeze-dryer for freeze-drying a sample in a pressure state of below the triple point of water according to an embodiment of the disclosure includes a freeze-drying chamber that is sealed and in which the sample is arranged, a first pump comprising an inlet connected to the freeze-drying chamber and configured to suck water vapor vaporized from the sample, an outlet configured to discharge the water vapor sucked, a storage tank having an inlet and an outlet formed therein and accommodating oil for maintaining seal during when the water vapor sucked from the inlet is moved to the outlet, an apparatus for separating moisture from oil connected to the first pump and separating moisture from the oil in the first pump, and a second pump connected to the apparatus for separating moisture from oil and generating a negative pressure in the apparatus for separating moisture from oil.

### TECHNICAL FIELD

The present disclosure relates to a vacuum freeze-dryer and a control method thereof, and more particularly, to a vacuum freeze-dryer including an apparatus for separating moisture from oil and a control method thereof.

### BACKGROUND ART

A freeze-dryer is used to dry a sample including aqueous solution or water by freezing the sample and sublimating ice in the frozen sample by reducing the pressure to a vacuum state below the pressure of water vapor (triple point) of the freezing temperature.

In most freeze-dryers, a vacuum pump is used to maintain the vacuum state below the triple point so that the ice in the frozen sample continues to sublimate.

Most freeze-dryers use a rotary vain pump to form a vacuum state below the triple point.

A rotary vain pump is filled with oil that maintains sealing of rotating vanes to form high vacuum below the triple point and performs a lubrication operation on the rotating vanes. However, when moisture is introduced into the oil of a rotary vain pump, an emulsification phenomenon in which oil is mixed with moisture by rotating vanes occurs so that it is difficult to maintain the sealing of the rotating vanes and the function of performing a lubrication operation on the rotating vanes deteriorates. Accordingly, the sealing inside the rotary vain pump is not completely maintained and the rotating vanes do not smoothly operate, so that it is a problem that forming high vacuum below the triple point is difficult.

To solve the above problem, a freeze-dryer using an existing rotary vain pump as a vacuum pump adopts a cold trap for collecting moisture by cooling the same, but moisture may not be efficiently removed from oil inside the pump because discharging the moisture collected by the cold trap.

Another existing freeze-dryer uses a high vacuum pump, such as a roots pump, a scroll pump, and the like, that is not affected by moisture, but there is a limit in a wide distribution because it is difficult and expensive to miniaturize the pump.

In another existing freeze-dryer, by discharging oil from a rotary vain pump to the outside to pass through a filter, moisture is removed from the oil and then the oil removed of moisture is circulated back to the rotary vain pump. However, it is difficult to frequently replace the filter so that the moisture filtered by the filter may not be efficiently discharged. Thus, the moisture may not be efficiently removed from the oil inside the pump.

### DESCRIPTION OF EMBODIMENTS

### Technical Problem

It is an objective of the present disclosure to provide a vacuum freeze-dryer in which, by efficiently removing moisture from the inside of a pump used to freeze-dry a sample in a pressure state of below the triple point of water, emulsification in which oil in the pump is mixed with moisture is minimized and lubricity and sealability of oil are improved, whereby the vacuum performance of the pump is improved and the efficiency of freeze-drying vacuum is maximized, and a control method of the vacuum freeze-dryer.

It is another objective of the present disclosure to provide a vacuum freeze-dryer in which, by efficiently removing moisture from water vapor inside a pump used to freeze-dry a sample in a pressure state of below the triple point of water, emulsification in which oil in the pump is mixed with moisture is minimized and lubricity and sealability of oil are improved, whereby the vacuum performance of the pump is improved and the efficiency of freeze-drying is maximized, and a control method of the vacuum freeze-dryer.

It is another objective of the present disclosure to provide a vacuum freeze-dryer in which, by efficiently removing moisture from oil in a pump used to freeze-dry a sample in a pressure state of below the triple point of water, emulsification in which the oil in the pump is mixed with moisture is minimized and lubricity and sealability of oil are improved, whereby the vacuum performance of the pump is improved and the efficiency of freeze-drying is maximized, and a control method of the vacuum freeze-dryer.

The technical objectives to be achieved by the disclosure are not limited to the above-described objectives, and other technical objectives that are not mentioned herein would be clearly understood by a person skilled in the art from the description of the present invention.

### Solution to Problem

According to an embodiment of the present disclosure, a vacuum freeze-dryer for freeze-drying a sample in a pressure state of below the triple point of water includes a freeze-drying chamber that is sealed and in which the sample is arranged, a first pump comprising an inlet connected to the freeze-drying chamber and configured to suck water vapor vaporized from the sample, an outlet configured to discharge the water vapor sucked, a storage tank having an inlet and an outlet formed therein and accommodating oil for maintaining seal during when the water vapor sucked from the inlet is moved to the outlet, an apparatus for separating moisture from oil connected to the first pump and separating moisture from the oil in the first pump, and a second pump connected to the apparatus for separating moisture from oil and generating a negative pressure in the apparatus for separating moisture from oil.

In an embodiment, the freeze-drying chamber may include a rotation member for rotating the sample.

In an embodiment, the apparatus for separating moisture from oil may include a first suction portion connected to the outlet of the first pump.

In an embodiment, the apparatus for separating moisture from oil may include a second suction portion connected to the storage tank of the first pump.

In an embodiment, the apparatus for separating moisture from oil may include a filter.

In an embodiment, the apparatus for separating moisture from oil may include a separation tank having a detention space in which, as time passes, oil with a relatively low specific gravity is disposed in an upper layer and moisture with a relatively high specific gravity is disposed in a lower layer.

In an embodiment, the apparatus for separating moisture from oil may include a return portion configured to return the oil disposed in the upper layer of the separation tank to the first pump.

In an embodiment, the return portion may include a main body extending from a lower portion to an upper portion of the separation tank and an entrance located in the oil in the upper layer by passing the moisture in the lower layer of the separation tank, whereby the moisture in the lower layer is not introduced into the entrance and the oil in the upper layer is introduced into the entrance to be returned to the first pump.

In an embodiment, the return portion may be connected to a first suction portion that is connected to the outlet of the first pump.

In an embodiment, the vacuum freeze-dryer may further include a suction pump provided between the first pump and the apparatus for separating moisture from oil and configured to suck the moisture from the storage tank of the first pump and transfer the moisture to the apparatus for separating moisture from oil.

In an embodiment, the second pump may include at least one selected from the group consisting of a piston pump, a plunger pump, a diaphragm pump, and a screw pump.

In an embodiment, the vacuum freeze-dryer may further include an auxiliary apparatus for separating moisture from oil provided between the first pump and the apparatus for separating moisture from oil and configured to suck the moisture from the storage tank of the first pump, separate oil included in the sucked moisture, return the oil to the apparatus for separating moisture from oil, and discharge the remaining moisture to the outside.

According to another embodiment of the disclosure, a control method of the vacuum freeze-dryer according to any one of the embodiments described above includes sucking, by the first pump connected to the freeze-drying chamber that is sealed and in which the sample is arranged, water vapor vaporized from the sample from the freeze-drying chamber, separating, by the apparatus for separating moisture from oil connected to the outlet of the first pump, the moisture and the oil discharged from the first pump from each other, and discharging the moisture separated from the oil to the outside, and returning the oil separated from the moisture to the first pump.

### Advantageous Effects of Disclosure

An effect of the present disclosure is to provide a vacuum freeze-dryer in which, by efficiently removing moisture from the inside of a pump used to freeze-dry a sample in a pressure state of below the triple point of water, emulsification in which oil in the pump is mixed with moisture is minimized and lubricity and sealability of oil are improved, whereby the vacuum performance of the pump is improved and the efficiency of freeze-drying is maximized, and a control method of the vacuum freeze-dryer.

Another effect of the present disclosure is to provide a vacuum freeze-dryer in which, by efficiently removing moisture from water vapor inside a pump used to freeze-dry a sample in a pressure state of below the triple point of water, emulsification in which oil of the pump is mixed with moisture is minimized and lubricity and sealability of oil are improved, whereby the vacuum performance of the pump is improved and the efficiency of freeze-drying is maximized, and a control method of the vacuum freeze-dryer.

Another effect of the present disclosure is to provide a vacuum freeze-dryer in which, by efficiently removing moisture from oil in a pump used to freeze-dry a sample in a pressure state of below the triple point of water, emulsification in which the oil in the pump is mixed with moisture is minimized and lubricity and sealability of oil are improved, whereby the vacuum performance of the pump is improved and the efficiency of freeze-drying is maximized, and a control method of the vacuum freeze-dryer.

The effects of the present disclosure are not limited to the above-described effects, and other various effects that are not described in the specification may be clearly understood from the following descriptions by one skilled in the art to which the present disclosure belongs.

### BRIEF DESCRIPTION OF DRAWINGS

FIG. 1 is a view schematically illustrating a vacuum freeze-dryer according to an embodiment of the disclosure.

FIG. 2 is a view illustrating a vacuum pump of a vacuum freeze-dryer according to an embodiment of the disclosure.

FIG. 3 is an enlarged view of a region A of FIG. 2.

FIG. 4 is a view illustrating an opening/closing device of a vacuum freeze-dryer according to an embodiment of the disclosure.

FIG. 5 is a view illustrating an embodiment of an apparatus for separating moisture from oil of a vacuum freeze-dryer according to an embodiment of the disclosure.

FIG. 6 is a view illustrating another embodiment of an apparatus for separating moisture from oil of a vacuum freeze-dryer according to another embodiment of the disclosure.

FIG. 7 is a view illustrating yet another embodiment of an apparatus for separating moisture from oil of a vacuum freeze-dryer according to yet another embodiment of the disclosure.

FIG. 8 is a view schematically illustrating a serial connection of a plurality of apparatuses for separating moisture from oil to a first pump of a vacuum freeze-dryer according to an embodiment of the disclosure.

FIG. 9 is a view schematically illustrating a parallel connection of a plurality of apparatuses for separating moisture from oil to a first pump of a vacuum freeze-dryer according to an embodiment of the disclosure.

FIG. 10 is a flowchart of a control method of a vacuum freeze-dryer, according to another embodiment of the disclosure.

FIG. 11 is a flowchart of a control method of a vacuum freeze-dryer, according to another embodiment of the disclosure.

### MODE OF DISCLOSURE

The present disclosure will now be described more fully with reference to the accompanying drawings, in which embodiments of the present disclosure are shown. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art.

Furthermore, the terms used in the specification are merely used to describe embodiments, and are not intended to limit the disclosure. An expression used in the singular encompasses the expression of the plural, unless it has a clearly different meaning in the context.

In the specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

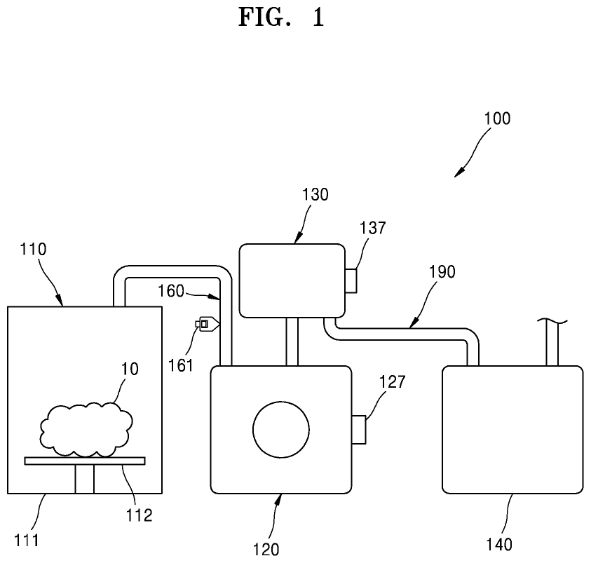

A vacuum freeze-dryer 100 according to an embodiment of the disclosure, as exemplarily illustrated in FIG. 1, may include a freeze-drying chamber 110, a first pump 120, an apparatus 130 for separating moisture from oil, and a second pump 140.

The vacuum freeze-dryer 100 is a freeze-dryer that dries a sample in a pressure state of below the triple point of water. In a pressure state of below the triple point of water, water included in a sample is directly vaporized from an ice state to a gas state bypassing a liquid state, so that the sample is dried.

The freeze-drying chamber 110 includes a chamber 111 having a closed space in which the sample 10 is arranged. The freeze-drying chamber 110, as exemplarily illustrated in FIG. 1, a rotation member 112 for rotating the sample 10 may be included in the chamber 111. Accordingly, as freeze-drying is uniformly performed in the entire sample 10, freeze-drying efficiency may be improved.

The first pump 120 is a device for sucking water vapor from the freeze-drying chamber 110 and discharging the water vapor to the outside. Accordingly, the freeze-drying chamber 110 is maintained in a pressure state of below the triple point of water so that water included in a sample may be vaporized from the ice state to the gas state.

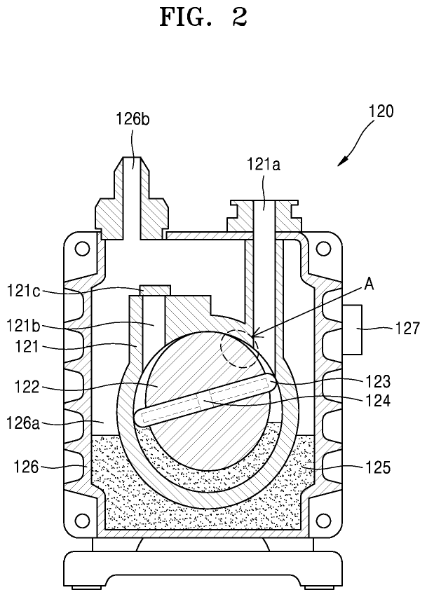

The first pump 120 may have various configurations for sucking water vapor from the freeze-drying chamber 110 and discharging the water vapor to the outside. For example, the first pump 120, as exemplarily illustrated in FIG. 2, may include a stator 121, a rotor 122, and an oil 125. In addition, the first pump 120 may further include a blade 123, an elastic member 124, a housing 126, and a first power supply device 127.

The stator 121 may include an inlet 121a that is connected to the freeze-drying chamber 110 and sucks the vaporized water vapor from the sample 10 and an outlet 121b discharging the sucked water vapor. The stator 121 may have various shapes, for example, a shape having a closed inner space of a cylinder shape. An exhaust valve 121c may be added to the outlet 121b. The exhaust valve 121c may block or enable discharging the water vapor from the outlet 121b to the inner space of the housing 126.

The rotor 122 may be a device that is installed inside the stator 121 and rotates to move the water vapor sucked in the inlet 121a toward the outlet 121b. The rotor 122 may have various shapes, for example, a shape of eccentrically rotating inside the stator 121 having a closed inner space of a cylinder shape.

The blade 123 may be a member that is accommodated in a hole formed in the rotor 122 to be capable of protruding. The blade 123 protrudes and rotates in close contact with the inner surface of the stator 121 during rotation, thereby transferring water vapor.

The elastic member 124 may be a member, such as a spring, to operate an elastic force to the blade 123 so that the blade 123 accommodated in the hole of the rotor 122 protrudes. Accordingly, the blade 123 may easily protrude during rotation to be easily in close contact with the inner surface of the stator 121. However, the disclosure is not limited thereto, and the blade 123 protrudes by a centrifugal force of the rotor 122 to be in close contact with the inner surface of the stator 121.

The oil 125 may be arranged between one end and the other end of the blade 123 in a gap between the stator 121 and the rotor 122. Accordingly, the oil 125 may perform a lubrication operation to facilitate the operations of the rotor 122 and the blade 123, and furthermore, perform a sealing maintenance operation between the stator 121 and the rotor 122 and between the blade 123 and the inner surface of the stator 121.

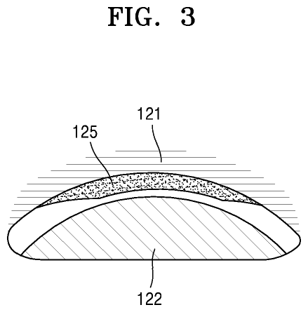

As exemplarily illustrated in FIG. 3, the gap filled with the oil 125 may exist between the inner surface of the stator 121 and the outer surface of the rotor 122, for example, in a portion indicated as a region A of FIG. 2, and when water vapor is introduced into the gap filled with the oil 125, emulsification in which oil is mixed with moisture may occur.

The housing 126 may be a device for covering the stator 121, the rotor 122, the blade 123, the elastic member 124, and the oil 125. Accordingly, the stator 121 and the like may easily withstand external shocks. The housing 126 may include various components. For example, the housing 126 may include a storage tank 126a where the oil 125 or water vapor is contained and an outlet 126b for discharging water vapor from the storage tank 126a to the outside. The storage tank 126a, as exemplarily illustrated in FIG. 2, may perform functions of containing the oil 125 and supplying the oil 125 into the stator 121. The outlet 126b of the housing 126 may perform a function of discharging the water vapor discharged from the outlet 121b of the stator 121 and introduced into the storage tank 126a or the water vapor generated from the moisture emulsified with the oil 125 in the storage tank 126a and contained in the storage tank 126a to the outside. The outlet 126b of the housing 126 may be spaced apart from the outlet 121b of the stator 121. However, the disclosure is not limited thereto, and the outlet 126b of the housing 126 may be directly connected to the outlet 131b of the stator 121. In this case, the exhaust valve 121c that opens and closes the outlet 121b of the stator 121 may be omitted. Although the present embodiment includes the housing 126 as one constituent element, the disclosure is not limited thereto, and the present embodiment may not include the housing 126 as a constituent element.

The first power supply device 127 may be a device for supplying power to the first pump 120. The first power supply device 127 may control the driving of the first pump 120 by supplying or cutting off power to the first pump 120, as necessary, to thus enable or disable the driving of the first pump 120.

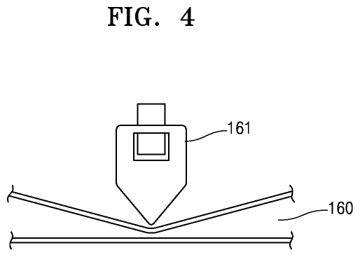

The freeze-drying chamber 110 and the inlet of the first pump 120, for example, the inlet 121a of the stator 121, may be connected by a first path 160 having a structure of a pipe such as a rubber hose and the like. The water vapor of the freeze-drying chamber 110 may be introduced into a vacuum pump 120 through the first path 160. The first path 160 may include a first opening/closing device 161 for opening or closing the first path 160. As the first opening/closing device 161 opens/closes the first path 160, as necessary, the movement of the water vapor from the freeze-drying chamber 110 to the vacuum pump 120 may be controlled. The first opening/closing device 161 may have various configurations for opening/closing the first path 160. For example, the first opening/closing device 161 may have, as exemplarily illustrated in FIG. 4, a structure such as a clamping device for ( ) opening/closing the first path 160 by releasing or pressing a rubber hose from the outside in the first path 160 formed of the rubber hose.

The apparatus 130 for separating moisture from oil may be a device that is connected to the first pump 120 and separates moisture from the inside of the first pump 120. Accordingly, the moisture inside the first pump 120 may be removed or reduced.

The apparatus 130 for separating moisture from oil may have various configurations connected to the first pump 120 to separate moisture from the inside of the first pump 120.

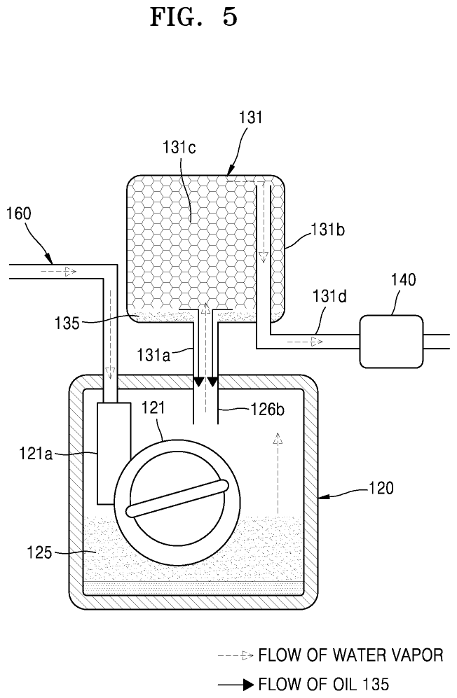

For example, the apparatus 130 for separating moisture from oil may be, as exemplarily illustrated in FIG. 5, a water vapor separation device 131 that is connected to the outlet 126b of the first pump 120 and separates water vapor from the inside of the first pump 120 through the outlet 126b of the first pump 120. Accordingly, the pressure of water vapor at the outlet 126b of the first pump 120 may be the same as or lower than the pressure of water vapor at the inlet 121a of the first pump 120 where the water vapor from the freeze-drying chamber 110 is sucked. Accordingly, the water vapor sucked through the inlet 121a of the first pump 120 is not mixed with the oil 125 of the first pump 120 and is discharged through the outlet 126b of the first pump 120, or the moisture mixed with the oil 125 of the first pump 120 is vaporized and discharged through the outlet 126b of the first pump 120. Thus, emulsification in which the oil 125 of the first pump 120 is mixed with the water vapor sucked through the inlet 121a of the first pump 120 may be minimized so as to improve lubricity and sealability of the oil 125, thereby improving vacuum performance of the first pump 120 and maximizing efficiency of freeze-drying.

The water vapor separation device 131 may include various components connected to the outlet 126b of the first pump 120 to separate water vapor from the inside of the first pump 120 through the outlet 126b of the first pump 120. For example, the water vapor separation device 131 may include, as exemplarily illustrated in FIG. 5, a suction portion 131a connected to the outlet 126b of the first pump 120. The suction portion 131a may function as a path along which the water vapor sucked from the inside of the first pump 120 and introduced into the water vapor separation device 131 through the outlet 126b of the first pump 120 passes. The water vapor passing through the suction portion 131a may include the water vapor sucked the freeze-drying chamber 110 through the inlet 121a of the first pump 120 or the oil in a gas state generated from the oil 125 of the first pump 120. As the water vapor is sucked from the outlet 126b of the first pump 120 to the water vapor separation device 131 through the suction portion 131a, the pressure of water vapor at the outlet 126b of the first pump 120 may be the same as or lower than the pressure of water vapor at the inlet 121a of the first pump 120.

The suction portion 131a may function as a path along which the oil 135 left in the water vapor separation device 131 after the water vapor is separated is returned to the inside of the first pump 120 through the outlet 126b of the first pump 120. In this case, the suction portion 131a may be configured such that the oil 135 left in the water vapor separation device 131 after the water vapor is removed is naturally or smoothly returned to the inside of the first pump 120 through the outlet 126b of the first pump 120. For example, the suction portion 131a may have a pipe shape vertically connecting a bottom portion, where the oil 135 is left, of the water vapor separation device 131 and a ceiling portion, where the outlet 126b is arranged, of the first pump 120. Furthermore, in order for the oil 135 to be smoothly introduced into the suction portion 131a, an oil inlet of the suction portion 131a through which the oil 135 is introduced maybe formed in the bottom portion of the water vapor separation device 131, and the bottom portion of the water vapor separation device 131 may be inclined downwards toward the oil inlet of the suction portion 131a. However, the oil 135 left in the water vapor separation device 131 after the water vapor is removed is not necessarily returned to the inside of the first pump 120 through the suction portion 131a, and may be returned to the inside of the first pump 120 through a separate path other than the suction portion 131a.

The water vapor separation device 131 may include a separation tank 131b for separating the water vapor sucked through the suction portion 131a from the oil in a gas state. The separation tank 131b may have a certain inner space in which the water vapor sucked through the suction portion 131a and the oil in a gas state may be contained. The water vapor and the oil in a gas state contained in the separation tank 131b are separated from each other as time passes and the water vapor is discharged to the outside and the oil is left in the separation tank 131b. The oil left in the separation tank 131b may be gathered in the bottom portion of the separation tank 131b, as time passes, and the oil 135 gathered in the bottom portion may be returned to the inside of the first pump 120 through the suction portion 131a and the outlet 126b of the first pump 120.

The water vapor separation device 131 may include a filter portion 131c arranged in the separation tank 131b. The filter portion 131c is a device for passing the water vapor contained in the separation tank 131b and not passing the oil contained therein. Accordingly, while the water vapor may be discharged from the separation tank 131b to the outside, the oil may remain in the separation tank 131b. The filter portion 131c may be formed of various filters including meshes having a size to pass the water vapor and not to pass the oil. As the filter portion 131c is arranged entirely in an inner space of the separation tank 131b, thereby increasing a filtering effect.

The water vapor separation device 131 may include a discharge portion 131d though which the water vapor discharged from the separation tank 131b to the outside passes. The discharge portion 131d may function as a path along which the water vapor discharged from the separation tank 131b to the outside passes. The discharge portion 131d may be arranged away from the suction portion 131a as far as possible. Accordingly, as the path and time for the water vapor sucked into the suction portion 131a to be discharged to the discharge portion 131d is extended as long as possible, an efficiency of separating oil from water vapor may be increased. For example, when the suction portion 131a is located at the bottom portion of the separation tank 131b, an entrance of the discharge portion 131d may be located, as exemplarily illustrated in FIG. 5, in the vicinity of a ceiling portion of the separation tank 131b. Arranging the filter portion 131c on the path along which the water vapor sucked into the suction portion 131a is discharged to the discharge portion 131d may improve the efficiency of separating oil from water vapor.

The second pump 140 may be a device that is connected to the apparatus 130 for separating moisture from oil and generates a negative pressure in the apparatus 130 for separating moisture from oil. The second pump 140 may, by generating a negative pressure in the apparatus 130 for separating moisture from oil, suck moisture from the first pump 120 to the apparatus 130 for separating moisture from oil and discharge the moisture from the apparatus 130 for separating moisture from oil to the outside. Accordingly, moisture may be separated from the oil inside the first pump 120, and thus, the moisture inside the first pump 120 may be removed or reduced.

The second pump 140 may have various configurations connected to the apparatus 130 for separating moisture from oil to generate a negative pressure in the apparatus 130 for separating moisture from oil. For example, when the apparatus 130 for separating moisture from oil is the water vapor separation device 131, the second pump 140 may be connected to the discharge portion 131d, as exemplarily illustrated in FIG. 5. Accordingly, by generating a negative pressured in the suction portion 131a, the separation tank 131b, and the discharge portion 131d of the water vapor separation device 131, the water vapor sucked from the first pump 120 to the separation tank 131b of the water vapor separation device 131 via the suction portion 131a may pass through the filter portion 131c to be discharged to the outside through the discharge portion 131d. The second pump 140 may generate a negative pressure of 600 mmHg or less. The second pump 140 may be a booster pump that is resistant to moisture. The second pump 140 may be at least one selected from the group consisting of a piston pump, a plunger pump, a diaphragm pump, and a screw pump.

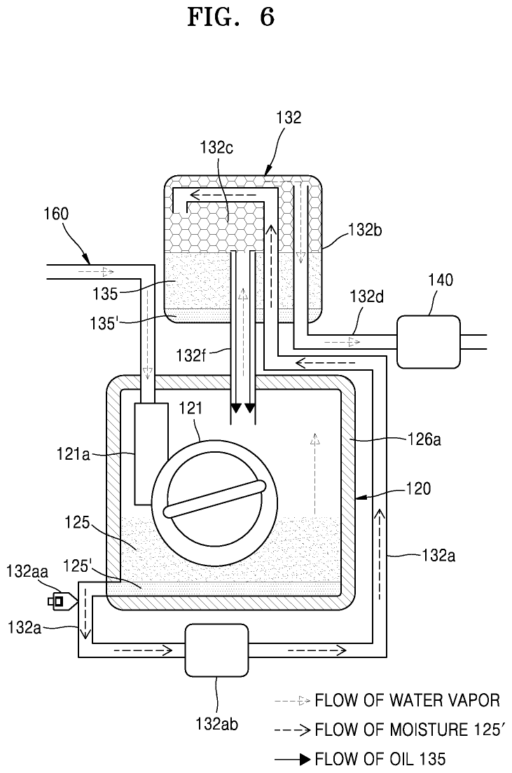

The apparatus 130 for separating moisture from oil may be, as exemplarily illustrated in FIG. 6, a moisture separation device 132 that is connected the storage tank 126a of the first pump 120 and removes moisture 125′ in the oil 125 contained in the storage tank 126a of the first pump 120. Accordingly, the oil 125 of the moisture 125′ inside the first pump 120 may be removed more quickly than removed by being vaporized, and thus, the time for the moisture 125′ remaining in the oil 125 may be minimized. Furthermore, the content of the moisture 125′ remaining in the oil 125 of the first pump 120 may decrease, and thus, the moisture 125′ remaining in the oil 125 may be quickly vaporized. Thus, emulsification in which the oil 125 of the first pump 120 is mixed with the water vapor sucked through the inlet 121a of the first pump 120 may be minimized so as to improve lubricity and sealability of the oil 125, thereby improving vacuum performance of the first pump 120 and maximizing efficiency of freeze-drying.

The moisture separation device 132 may include various configurations connected to the storage tank 126a of the first pump 120 to remove the moisture 125′ in the oil 125 contained in the storage tank 126a of the first pump 120. For example, the moisture separation device 132 may include, as exemplarily illustrated in FIG. 6, a suction portion 132a connected to the storage tank 126a of the first pump 120. The suction portion 132a may function as a path along which the moisture 125′ sucked from the storage tank 126a of the first pump 120 to the moisture separation device 132 passes. The suction portion 132a may be opened or closed by a suction valve 131aa. A fluid passing through the suction portion 132a may include the moisture 125′ contained in the storage tank 126a of the first pump 120 or the oil 125 mixed with the moisture 125′ in the storage tank 126a of the first pump 120. As the moisture 125′ is sucked from the storage tank 126a of the first pump 120 to the moisture separation device 132 through the suction portion 132a, the moisture 125′ in the oil 125 contained in the storage tank 126a of the first pump 120 may be separated.

The storage tank 126a of the first pump 120 may contain a mixture of the oil 125 and the moisture 125′. Accordingly, the suction portion 132a may be connected to a portion of the storage tank 126a of the first pump 120 in contact with an area where the oil 125 and the moisture 125′ are mixed with each other and contained. However, in the storage tank 126a of the first pump 120, as time passes, the moisture 125′ with a relatively high specific gravity may be disposed in a lower layer and the oil 125 with a relatively low specific gravity may be disposed in an upper layer. Accordingly, the suction portion 132a may be connected to, as exemplarily illustrated in FIG. 6, a portion of the storage tank 126a of the first pump 120 in contact with an area where the moisture 125′ with a relatively high specific gravity is contained, for example, a bottom portion or a side lower end portion of the storage tank 126a or the vicinity thereof.

The moisture separation device 132 may include a suction pump 132ab that is connected to the suction portion 132a and applies a negative pressure to the suction portion 132a. Accordingly, the moisture 125′ may be smoothly sucked from the storage tank 126a of the first pump 120 to the suction portion 132a, and furthermore, the moisture 125′ may be smoothly moved to the moisture separation device 132. The suction pump 132ab may be arranged in various manners on a path of the suction portion 132a connecting the storage tank 126a of the first pump 120 to the moisture separation device 132.

The moisture separation device 132 may include a separation tank 132b for separating moisture 135′ and the oil 135 sucked through the suction portion 132a from each other. The separation tank 132b may have a certain space in which the moisture 135′ and the oil 135 sucked through the suction portion 132a are contained. The moisture 135′ and the oil 135 contained in the separation tank 132b may be separated as time passes into moisture 135′ with a relatively high specific gravity disposed in a lower layer and moisture 135 with a relatively low specific gravity in an upper layer. As arranged as above, the oil 135 and the moisture 135′ may be separated and contained, as exemplarily illustrated in FIG. 6. The moisture 135′ that is separated from the oil 135 in the separation tank 132b may be naturally vaporized as time passes, vaporized by the negative pressure according to the operation of the second pump 140 described below, or the first pump 120, or vaporized by heat generated according to the operation of the suction pump 132ab, the second pump 140, or the like, and then discharged to the outside. The oil 135 separated from the moisture 135′ in the separation tank 132b may be moved and returned to the storage tank 126a of the first pump 120.

A device for preventing bumping that is a phenomenon where liquid oil is heated over the boiling point to suddenly boil, for example, at least one selected from the group consisting of a boiling stone, a filter, a porous net, and the like may be provided in the oil 135 in the upper layer contained in the separation tank 132b. The device may prevent a loss of the oil 135 that is discharged to the outside by a bumping phenomenon.

The moisture separation device 132 may include a filter portion 132c arranged in the separation tank 132b. The moisture 135′ and the oil 135 sucked and contained in the separation tank 132b may be naturally vaporized, vaporized by the negative pressure according to the operation of the second pump 140, or vaporized by heat generated according to the operations of the first pump 120, the suction pump 132ab, the second pump 140, or the like. The moisture 135′ and the oil 135 vaporized as above may be discharged to the outside by the negative pressure according to the operation of the second pump 140. The filter portion 132c may pass the moisture 135′ that is vaporized and may not pass the oil 135 that is vaporized, of the moisture 135′ and the oil 135 that are vaporized as above. The filter portion 132c may prevent the oil 135 contained in the separation tank 132b from being vaporized and discharged with the water vapor to the outside, when the moisture 135′ sucked and contained in the separation tank 132b is vaporized to the water vapor and discharged to the outside. Accordingly, the moisture 135′ that is vaporized to the water vapor in the separation tank 132b may be discharged to the outside of the separation tank 132b and the oil 135 that is vaporized may remain inside the separation tank 132b. The oil 135 that is vaporized and remains by the filter portion 132c in the separation tank 132b may be liquefied, as time passes, and stored in an oil layer of the separation tank 132b. The filter portion 132c may include various filters including meshes having a size to pass water vapor that is the moisture 135′ that is vaporized and not to pass the oil 135 that is vaporized.

The moisture separation device 132 may include a discharge portion 132d through which the water vapor discharged to the outside from the separation tank 132b passes. The discharge portion 132d may function as a path along which the water vapor that is the moisture 135′ contained in the separation tank 132b and vaporized is discharged to the outside from the separation tank 132b. The discharge portion 132d may be arranged such that the water vapor that is the moisture 135′ contained in the separation tank 132b and vaporized is introduced into the discharge portion 132d via the filter portion 132c. This is because when the moisture 135′ contained in the separation tank 132b is vaporized to water vapor, the oil 135 contained with the moisture 135′ may be vaporized, and thus, the oil 135 that is vaporized while moving together with the water vapor may be filtered by the filter portion 132c so as not to be discharged to the outside.

The second pump 140 for generating a negative pressure in the moisture separation device 132 may be connected to the moisture separation device 132. As the second pump 140 generates a negative pressure in the separation tank 132b and the discharge portion 132d, the water vapor generated in the separation tank 132b may pass through the filter portion 132c to be discharged to the outside through the discharge portion 132d. The second pump 140 may generate a negative pressure of 600 mmHg or less. The second pump 132e may be a booster pump that is resistant to moisture.

The moisture separation device 132 may include a return portion 132f for returning the oil 135 separated from the moisture 135′ in the separation tank 132b to the first pump 120. The return portion 132f may function as a path along which the oil separated from the moisture in the separation tank 132b and contained is returned to the first pump 120. The return portion 132f may be configured such that the oil 135 separated from the moisture 135′ in the separation tank 132b is naturally or smoothly returned to the storage tank 126a of the first pump 120.

In the separation tank 132b, as time passes, the moisture 135′ with a relatively high specific gravity may be disposed in the lower layer and the moisture 135 with a relatively low specific gravity may be disposed in the upper layer. Accordingly, for example, as exemplarily illustrated in FIG. 6, the return portion 132f may have a pipe shape such that an entrance of the return portion 132f is arranged not to contact the moisture layer of the separation tank 132b but to contact the oil layer, a main body of the return portion 132f extends vertically downwards from the entrance, and an exist of the return portion 132f is connected to the inside of the storage tank 126a of the first pump 120. Accordingly, as the moisture 135′ disposed in the lower layer of the separation tank 132b does not contact the entrance of the return portion 132f, the moisture 135′ may not be introduced into the return portion 132f, and as the oil 135 disposed in the upper layer of the separation tank 132b is in contact with the entrance of the return portion 132f, the oil 135 may be naturally and smoothly introduced into the return portion 132f.

In this state, the main body of the return portion 132f, which extends into the inside of the separation tank 132b, may function as a weir for preventing the moisture 135′ disposed in the lower layer of the separation tank 132b from being introduced into the entrance of the return portion 132f. As such, the oil 135 introduced into the entrance of the return portion 132f may be naturally and smoothly returned to the storage tank 126a of the first pump 120 through the main body of the return portion 132f extending vertically downwards. However, the return portion 132b is not limited thereto, and may include various other configurations for returning the oil 135 separated from the moisture 135′ in the separation tank 132b to the first pump 120.

The return portion 132f, as exemplarily illustrated in FIG. 6, may also function as a path connected to the outlet 126b of the first pump 120, and along which the water vapor passes from the inside of the first pump 120 to the moisture separation device 132 through the outlet 126b of the first pump 120. The water vapor that passes through the return portion 132f may include the water vapor sucked from the freeze-drying chamber 110 through the inlet 121a of the first pump 120, the water vapor vaporized from the moisture 125′ of the first pump 120, or the oil in a gas state vaporized from the oil 125 of from the first pump 120. The water vapor passing through the return portion 132f may pass through the return portion 132f naturally or by the negative pressure according to the operation of the second pump 140. As such, of the fluid moved from the first pump 120 to the moisture separation device 132 through the return portion 132f, the water vapor may pass through the filter portion 132c to be discharged to the outside through the discharge portion 132d, and the oil in a gas state may not pass through the filter portion 132c so to be liquefied as time passes and contained in the oil layer of the separation tank 132b.

An auxiliary apparatus for separating moisture from oil may be further included between the first pump 120 and the apparatus 130 for separating moisture from oil. The auxiliary apparatus for separating moisture from oil may suck moisture from the storage tank 126a of the first pump 120, separate oil included in the sucked moisture, return the separated oil to the apparatus 130 for separating moisture from oil, and discharges the remaining moisture to the outside. The auxiliary apparatus for separating moisture from oil may include various components.

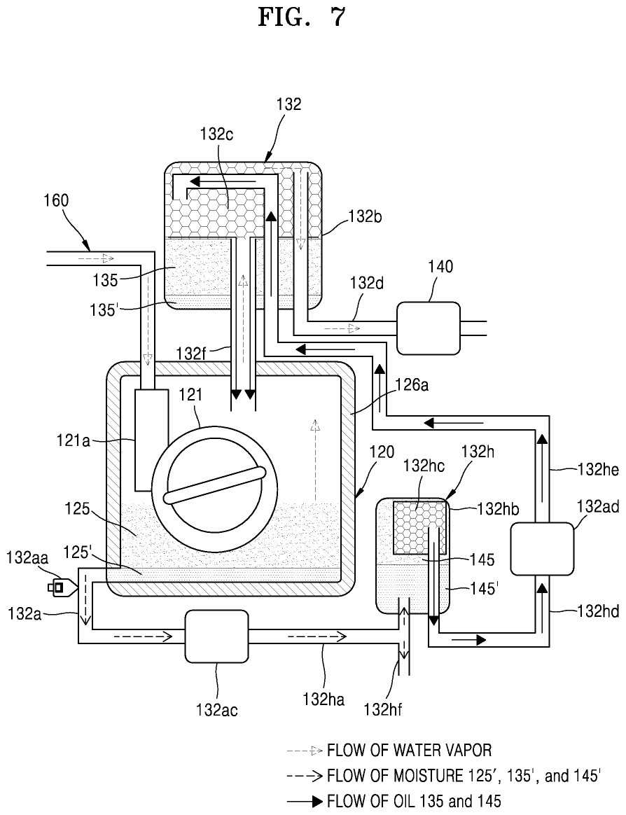

For example, when the apparatus 130 for separating moisture from oil is the moisture separation device 132, the moisture separation device 132 may include, as exemplarily illustrated in FIG. 7, an auxiliary moisture separation device 132h arranged between a first suction pump 132ac and a moisture detention device 132. The auxiliary moisture separation device 132h may suck the moisture 125′ discharged from the storage tank 126a of the first pump 120 through the suction portion 132a and the oil 125 included in the moisture 15′, according to the operation of the first suction pump 132ac, separate the moisture 125′ and the oil 125 that are sucked, from each other, and the oil 145 that is separated may be returned to the moisture separation device 132 and the moisture 145′ that is separated may be discharged to the outside.

The auxiliary moisture separation device 132h may include an auxiliary suction portion 132ha for sucking the moisture 125′ of the first pump 120 and the oil 125 included in the moisture 125′, according to the operation of the first suction pump 132ac.

The auxiliary moisture separation device 132h may include an auxiliary separation tank 132hb for separating the moisture 125′ and the oil 125 sucked through the auxiliary suction portion 132ha from each other. Of the fluid sucked into the auxiliary separation tank 132hb, as time passes, moisture 145′ with a relatively high specific gravity may be disposed in a lower layer and moisture 145 with a relatively low specific gravity may be disposed in an upper layer. As such, the moisture 145′ in the lower layer separated from the auxiliary separation tank 132hb may be discharged to the outside and the oil 145 in the upper layer may be returned to the separation tank 132b of the moisture separation device 132.

The auxiliary moisture separation device 132h may include an auxiliary filter portion 132hc in the auxiliary separation tank 132hb. The auxiliary filter portion 132hc may filter, when the oil 145 in the upper layer of the auxiliary separation tank 132hb is returned to the separation tank 132b of the moisture separation device 132, foreign materials included in the oil 145 so that pure oil may be returned to the separation tank 132b of the moisture separation device 132. The auxiliary filter portion 132hc may have various filters including meshes having a size to pass the oil 145 and not to pass the foreign materials.

The auxiliary moisture separation device 132h may include an auxiliary discharge portion 132hd for discharging the oil 145 from the auxiliary separation tank 132hb to the moisture separation device 132. The auxiliary discharge portion 132hd may be arranged such that the moisture 145′ disposed in the lower layer of the auxiliary separation tank 132hb is not discharged and the oil 145 disposed in the upper layer of the auxiliary separation tank 132hb is discharged. For example, a main body of the auxiliary discharge portion 132hd penetrates a bottom portion of the auxiliary separation tank 132hb to extend to a ceiling portion by passing through the moisture 145′ in the lower layer, and an entrance of the auxiliary discharge portion 132hd may be arranged at a position contacting the oil 145 in the upper layer.

The auxiliary moisture separation device 132h may include a second suction pump 132ad connected to the auxiliary discharge portion 132hd. The second suction pump 132ad may generate a negative pressure in the auxiliary separation tank 132hb and the auxiliary discharge portion 132hd to discharge the oil 145 in the upper layer of the auxiliary separation tank 132hb through the auxiliary discharge portion 132hd. The oil 145 may be returned from the auxiliary separation tank 132hb to the moisture separation device 132 through the auxiliary discharge portion 132hd according to the operation of the second suction pump 132ad.

The auxiliary moisture separation device 132h may include an auxiliary moisture discharge portion 132hf connected to the auxiliary separation tank 132hb to discharge the moisture 145′ contained in the auxiliary separation tank 132hb to the outside. The auxiliary moisture discharge portion 132hf may be connected to the auxiliary suction portion 132ha. In this case, an opening/closing device is provided on a path of the auxiliary suction portion 132ha, and when the moisture 145′ from the auxiliary separation tank 132hb is discharged to the outside through the auxiliary moisture discharge portion 132hf, the suction of moisture through the auxiliary suction portion 132ha may be stopped as the opening/closing device operates. However, the disclosure is not limited thereto, and the auxiliary moisture discharge portion 132hf may be directly connected to the auxiliary separation tank 132hb, not to the auxiliary suction portion 132ha so that the moisture 145′ may be discharged from the auxiliary separation tank 132hb to the outside.

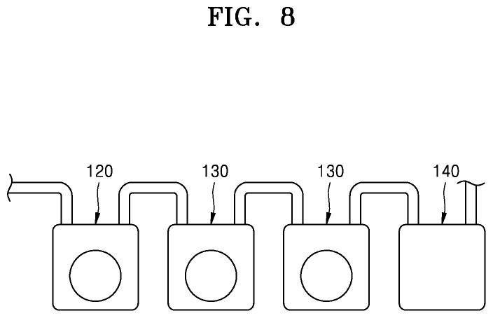

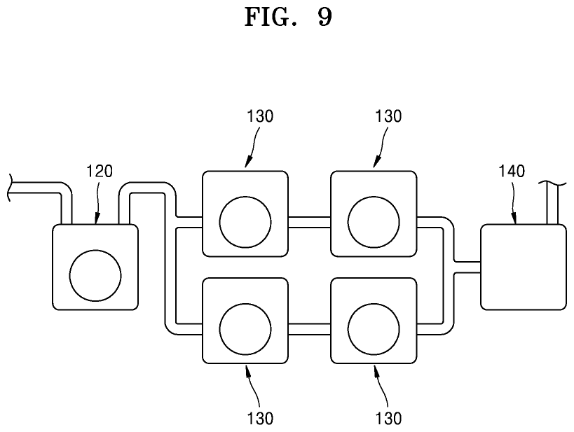

The apparatus 130 for separating moisture from oil may be connected to the first pump 120 in various manners. For example, one apparatus 130 for separating moisture from oil may be, as exemplarily illustrated in FIG. 1, connected to the first pump 120. However, the disclosure is not limited thereto, and as exemplarily illustrated in FIG. 8, a plurality of apparatuses 130 for separating moisture from oil may be connected in series to the first pump 120, or as exemplarily illustrated in FIG. 9, a plurality of apparatuses 130 for separating moisture from oil may be connected in parallel to the first pump 120.

The apparatus 130 for separating moisture from oil may further include, as exemplarily illustrated in FIG. 1, a second power supply device 137 for supplying power to the apparatus 130 for separating moisture from oil. The second power supply device 137 may control the driving of the apparatus 130 for separating moisture from oil by supplying or cutting off power to the apparatus 130 for separating moisture from oil, as necessary, to thus enable or disable the driving of the apparatus 130 for separating moisture from oil.

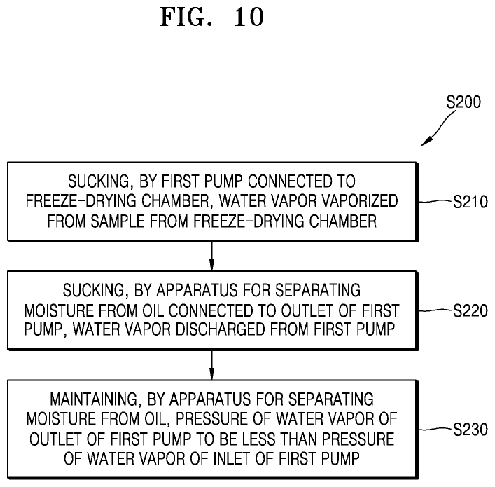

A control method (S200) of a vacuum freeze-dryer according to another embodiment of the disclosure may include, as exemplarily illustrated in FIG. 10, sucking, by the first pump 120 connected to the freeze-drying chamber 110, water vapor vaporized from the sample 10 from the freeze-drying chamber 110 (S210). Here, the vacuum freeze-dryer may be the vacuum freeze-dryer 100 according to the embodiment described above.

The control method (S200) of a vacuum freeze-dryer according to the present embodiment may include sucking, by the apparatus 130 for separating moisture from oil connected to the outlet 126b of the first pump 120, water vapor discharged from the first pump 120 (S220). Here, the apparatus 130 for separating moisture from oil may be the water vapor separation device 131 of a vacuum freeze-dryer according to the embodiment described above. Accordingly, the pressure of water vapor in the outlet portion 126b of the first pump 120 may be reduced.

When the first pump 120 is driven to suck water vapor from the inlet 121a and transfer the sucked water vapor to the outlet 126b, the pressure of the outlet 126b of the first pump 120 may be relatively higher than the pressure of the inlet 121a, and thus, due to such a pressure difference, emulsification in which the oil 125 is mixed with water vapor may occur. In this state, as the apparatus 130 for separating moisture from oil sucks and remove the water vapor of the outlet 126b of the first pump 120, the pressure of water vapor of the outlet 126b is lowered so that a difference between the pressure of the outlet 126b and the pressure of the inlet 121a may be reduced. Accordingly, by preventing the oil 125 from being mixed with the water vapor, emulsification in which the oil 125 is mixed with water vapor may be much prevented. Accordingly, the lubricity and sealability of the oil 125 may be improved according to the prevention of emulsification by the apparatus 130 for separating moisture from oil. When the pressure of water vapor of the outlet 126b of the first pump 120 is maintained, by the apparatus 130 for separating moisture from oil, to be identical to the pressure of water vapor of the inlet 121a, such emulsification may be completely prevented so that the lubricity and sealability of the oil 125 may be much improved.

The control method (S200) of a vacuum freeze-dryer according to the present embodiment may include maintaining, by the apparatus 130 for separating moisture from oil, the pressure of water vapor of the outlet 126b of the first pump 120 to be less than the pressure of water vapor of the inlet 121a of the first pump 120 (S230). Accordingly, the water vapor already emulsified in the oil 125 may be vaporized by the driving of the first pump 120. Accordingly, by removing the moisture emulsified in the oil 125, vacuum characteristics of the first pump 120 may be improved. In other words, as the apparatus 130 for separating moisture from oil continuously lowers the pressure of water vapor of the outlet 126b of the first pump 120 so that the pressure of water vapor of the outlet 126b is maintained to be less than the pressure of water vapor of the inlet 121a, balance between emulsification and moisture vaporization in the oil 125 is induced to be deviated toward the moisture vaporization, thereby improving the vacuum characteristics of the pump.

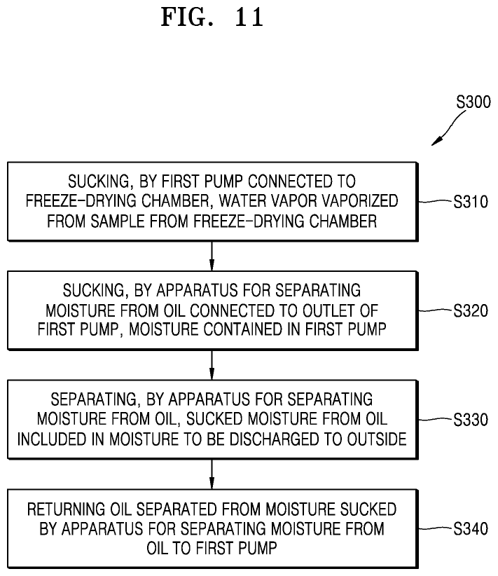

A control method (S300) of a vacuum freeze-dryer according to another embodiment of the disclosure may include, as exemplarily illustrated in FIG. 11, sucking, by the first pump 120 connected to the freeze-drying chamber 110, water vapor vaporized from the sample 10 from the freeze-drying chamber 110 (S310). Here, the vacuum freeze-dryer may be the vacuum freeze-dryer 100 according to the embodiment described above.

The control method (S300) of a vacuum freeze-dryer according to the present embodiment may include sucking, by the apparatus 130 for separating moisture from oil connected to the first pump 120, moisture contained in the first pump 120 (S320). Here, the apparatus 130 for separating moisture from oil may be the moisture separation device 132 of a vacuum freeze-dryer according to the embodiment described above. Accordingly, the moisture contained in the first pump 120 may be removed.

The control method (S300) of a vacuum freeze-dryer according to the present embodiment may include separating, by the apparatus 130 for separating moisture from oil, the sucked moisture from the oil included in the moisture to be discharged to the outside (S330). Accordingly, the moisture sucked into the apparatus 130 for separating moisture from oil may be removed.

The method of separating, by the apparatus 130 for separating moisture from oil, the sucked moisture from the oil included in the moisture to be discharged to the outside may include vaporizing the moisture to water vapor to be separated from the oil and discharging the moisture to the outside.

Another method of separating, by the apparatus 130 for separating moisture from oil, the sucked moisture from the oil included in the moisture to be discharged to the outside may include arranging, as time passes, moisture with a relatively high specific gravity to be disposed in a lower layer and oil with a relatively low specific gravity to be disposed in an upper layer, so as to be separated from each other, and then, discharging the moisture disposed in the lower layer to the outside of the moisture detention device 130.

As such, the moisture separated from the oil by the apparatus 130 for separating moisture from oil and then discharged may include oil. Accordingly, the moisture separated from the oil by the apparatus 130 for separating moisture from oil and then discharged may circulate back to the apparatus 130 for separating moisture from oil.

In this state, the moisture separated from the oil by the apparatus 130 for separating moisture from oil and then discharged may be joined with the moisture sucked from the first pump 120 to the apparatus 130 for separating moisture from oil and circuited to the apparatus 120 for separating moisture from oil. The moisture discharged from the apparatus 130 for separating moisture from oil and the moisture sucked from the first pump 120 may include oil. Accordingly, the moisture discharged from the apparatus 130 for separating moisture from oil and the moisture sucked from the first pump 120 may pass through the auxiliary apparatus 132h for separating moisture from oil and circulates to the apparatus 130 for separating moisture from oil. The moisture discharged from the apparatus 130 for separating moisture from oil and the moisture sucked from the first pump 120 may be separately arranged by the auxiliary apparatus 132h for separating moisture from oil, as time passes, as the oil in the upper layer and the moisture in the lower layer. The oil in the upper layer separated as above may be returned to the apparatus 130 for separating moisture from oil, and the moisture in the lower layer may be discharged to the outside.

The control method (S300) of a vacuum freeze-dryer according to the present embodiment may include returning the oil separated from the moisture sucked by the apparatus 130 for separating moisture from oil to the first pump 120 (S340). Accordingly, the oil separated in the apparatus 130 for separating moisture from oil may be returned to the first pump 120.

While the disclosure has been particularly shown and described with reference to preferred embodiments using specific terminologies, the embodiments and terminologies should be considered in descriptive sense only and not for purposes of limitation. Therefore, it will be understood by those of ordinary skill in the art that various changes in form and details may be made therein without departing from the spirit and scope of the disclosure as defined by the following claims.

### INDUSTRIAL APPLICABILITY

An embodiment of the present disclosure may be used for a vacuum freeze-dryer and a control method thereof.

1. A vacuum freeze-dryer for freeze-drying a sample in a pressure state of below the triple point of water, the vacuum freeze-dryer comprising:
a freeze-drying chamber that is sealed and in which the sample is arranged;
a first pump comprising an inlet connected to the freeze-drying chamber and configured to suck water vapor vaporized from the sample, an outlet configured to discharge the water vapor sucked, a storage tank having an inlet and an outlet formed therein and accommodating oil for maintaining seal during when the water vapor sucked from the inlet is moved to the outlet;
an apparatus for separating moisture from oil connected to the first pump and separating moisture from the oil in the first pump; and
a second pump connected to the apparatus for separating moisture from oil and generating a negative pressure in the apparatus for separating moisture from oil.

2. The vacuum freeze-dryer of claim 1, wherein the freeze-drying chamber comprises a rotation member for rotating the sample.

3. The vacuum freeze-dryer of claim 1, wherein the apparatus for separating moisture from oil comprises a first suction portion connected to the outlet of the first pump.

4. The vacuum freeze-dryer of claim 1, wherein the apparatus for separating moisture from oil comprises a second suction portion connected to the storage tank of the first pump.

5. The vacuum freeze-dryer of claim 1, wherein the apparatus for separating moisture from oil comprises a filter.

6. The vacuum freeze-dryer of claim 1, wherein the apparatus for separating moisture from oil comprises a separation tank having a detention space in which, as time passes, oil with a relatively low specific gravity is disposed in an upper layer and moisture with a relatively high specific gravity is disposed in a lower layer.

7. The vacuum freeze-dryer of claim 6, wherein the apparatus for separating moisture from oil comprises a return portion configured to return the oil disposed in the upper layer of the separation tank to the first pump.

8. The vacuum freeze-dryer of claim 7, wherein the return portion comprises a main body extending from a lower portion to an upper portion of the separation tank and an entrance located in the oil in the upper layer by passing the moisture in the lower layer of the separation tank, whereby the moisture in the lower layer is not introduced into the entrance and the oil in the upper layer is introduced into the entrance to be returned to the first pump.

9. The vacuum freeze-dryer of claim 7, wherein the return portion is connected to a first suction portion that is connected to the outlet of the first pump.

10. The vacuum freeze-dryer of claim 1, further comprising a suction pump provided between the first pump and the apparatus for separating moisture from oil and configured to suck the moisture from the storage tank of the first pump and transfer the moisture to the apparatus for separating moisture from oil.

11. The vacuum freeze-dryer of claim 1, wherein the second pump comprises at least one selected from the group consisting of a piston pump, a plunger pump, a diaphragm pump, and a screw pump.

12. The vacuum freeze-dryer of claim 1, further comprising an auxiliary apparatus for separating moisture from oil provided between the first pump and the apparatus for separating moisture from oil and configured to suck the moisture from the storage tank of the first pump, separate oil included in the sucked moisture, return the oil to the apparatus for separating moisture from oil, and discharge the remaining moisture to the outside.

13. A control method of the vacuum freeze-dryer according to claim 1, the method comprising:
sucking, by the first pump connected to the freeze-drying chamber that is sealed and in which the sample is arranged, water vapor vaporized from the sample from the freeze-drying chamber;
separating, by the apparatus for separating moisture from oil connected to the outlet of the first pump, the moisture and the oil discharged from the first pump from each other; and
discharging the moisture separated from the oil to the outside; and
returning the oil separated from the moisture to the first pump.
